(19) United States
(12) Patent Application Publication
(10) Pub. No.: US 2008/0085334 A1
(43) Pub. Date: Apr. 10, 2008

(54) Hot Runner System Sensor

(75) Inventor: Daniel Wayne Barnett, Georgia, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd., Bolton (CA)

(21) Appl. No.: 11/548,105

(22) Filed: Oct. 10, 2006

(51) Int. Cl. B28B 17/00

(52) U.S. Cl. 425/110

(57) ABSTRACT

A plug for use with a residual hole of a passageway in a hot runner system manifold may include an external surface for sealing with the residual hole, wherein a portion of the external surface is in direct contact with the resin in the passageway, a cavity having an internal surface that does not contact the resin, and a sensor secured to the internal surface using chemical vapor deposition, physical vapor deposition, plasma spray, or an adhesive. An ejector pin may include a sensor secured to the sidewall using chemical vapor deposition, physical vapor deposition, plasma spray, or an adhesive. A mold may include two inserts each an external surface and an internal surface defining a mold cavity. A sensing element may be secured to the external surface the first or second mold inserts wherein the sensing element does not contact the internal surface of the mold cavity.

### TECHNICAL FIELD

The present disclosure relates to molding systems and more particularly, relates to sensors for use in injection molding systems.

### BACKGROUND INFORMATION

Hot runner systems 1, FIG. 1, are well known in the art. A typical hot runner system 1 generally transfers molten plastic or metal (hereinafter “resin”) from a machine injection unit 2 to a mold 9 through a series of heated melt channels 7. A hot runner backing plate 3 and a manifold plate 4 are typically secured to a stationary platen on the injection molding machine and define a cavity 5 sized and shaped to accept a manifold 6. In practice, the machine injection unit 2 forces resin under high temperature and pressure through the melt channels 7 of the manifold 6 which distributes the resin to one or more nozzles 8 (typically either a valve gated or thermally gated nozzle) wherein the resin fills the mold 9 as is well known in the prior art.

Referring specifically to FIG. 2, a cross-section of the manifold 6 is shown. The resin enters the manifold 6 at point 10 and flows through a passageway 11 formed within the manifold 6 to the nozzles 8. In a typical hot runner system 1, the manifold 6 is constructed from a solid piece of metal such as steel. A CNC machine is used to drill the manifold 6 to form the passageway 11. In order to maintain equal flow conditions at the various nozzles 8, the passageway 11 often has a complex shape with various parts/segments of the passageway 11 at different levels/positions within the manifold 6 relative to the inlet 10. Because the CNC machine can only bore straight in one direction within the manifold 6, plugs 14 (FIGS. 2 & 3) are often necessary to fill in the residual holes 15 formed as a by-product of the machining process. Unfortunately, the plugs 14 in the residuals holes 15 are prone to leakage.

During the operation of the hot runner system 1, a heating device 12 may be used to regulate the temperature and/or pressure of the resin within the manifold to ensure that the resin does not become too cool and solidify or break-down from excessive heat. Occasionally, threaded holes 17 are bored in the manifold 6 along the passageway 11 and sensors 16, FIG. 2, are threaded into the holes 17 in order to sense the pressure during molding. While these sensors 16 are generally effective, the known sensors 16 require boring additional holes 17 into the manifold 6. The addition of these holes 17 increases labor costs, weakens the overall structural strength of the manifold 6, creates additional areas for resin leakage, and creates additional areas were resin may not flow and degrade. Resin leaking from the holes 17 can fill the cavity 5 formed by the backing plate 3 and a manifold plate 4, solidify, and seriously damage the hot runner system 1.

Upon leaving the hot runner system 1, the resin flows into a mold stack 101, FIG. 7, wherein the part 108 is produced. A typical mold stack 101 may feature three plates, namely, a core plate 102, a cavity plate 104, and an ejector plate 103. Resin is introduced into the cavity 106 formed by the core and cavity plates 102, 104 and forms the part 108 being manufactured. Once the part 108 has sufficiently solidified, the core plate 102 may move in the direction of arrows 110 away from the cavity plate 104 (which is usually stationary) to allow the part 108 to be removed from the plates 102, 104 as is well known to those skilled in the art. However, the part 108 often remains attached to the core plate 102 and one or more ejector pins 112 may be used to separate the part 108 from the core plate 102. The ejector pins 112 extend outwardly from the core plate 102 and push against the part 108, thereby separating the part 108 from the core plate 102.

The force exerted by the ejector pins 112 against the part 108 must be sufficiently large to overcome the forces holding the part 108 to the core plate 102. However, if the force exerted by the ejector pin 112 is too large, the ejector pins 112 can damage the part 108. While it is known to place a pressure sensor 118 between the end 117 of the ejector pin 112 and the ejector bolt 119 to monitor the pressure exerted by the ejector pin 112, this arrangement suffers from several limitations.

For example, retrofitting this arrangement into an existing mold stack 101 requires modification of the mold stack 101 and introduces additional stacking tolerances to the manufacturing process. Adding the pressure sensor 118 between the piston bolt 119 and end 117 of the ejector pin 112 moves the ejector pin 112 outwards beyond the molding surface 120 of the core plate 102 and adds an additional component (with its own production tolerances). In an existing mold stack 101, the ejector pin 112 and/or the ejector plate 103 must be modified since the distal end of the ejector pin 112 will extend into the cavity 106 and the part 108 will be molded around the distal end of the ejector pin 112. Additionally, the tolerances of the pressure sensor 118 add further complication since it must be factored into the design of the ejector pin 112.

Another limitation of this arrangement is that the pressure sensor 118 is difficult to fit between the bolt 119 and the end 117 of the ejector pin 112. For example, in a typical application, there is very little space to route the wires 121 connecting the sensor 118 to a processor (not shown). Furthermore, the wires 121 are often routed close to moving parts (e.g., the bolt 119) and may become damaged if they come into contact with a moving part.

Yet a further limitation of this arrangement is that the pressure sensor 118 wears out quickly. The pressure sensor 118 directly contacts the ejector bolt 119 and the end 117 of the ejector pin 112. Because the bolt 119 and the ejector pin 112 move slightly, the pressure sensor 118 is subjected to constant friction that can damage the pressure sensor 118.

It is important to note that the present disclosure is not intended to be limited to a system or method which must satisfy one or more of any stated objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

According to one embodiment, a hot runner manifold system comprises a manifold having at least one passageway including at least one inlet, outlet, and residual hole and a sensor sized and shaped to fit within the residual hole. The sensor preferably includes a plug for sealing the residual hole and includes a substrate (preferably disposed proximate a base of a cavity formed in a shank region of the plug). An external surface of the substrate is adapted to be in direct contact with a resin within the passageway. A sensing element is disposed on the internal surface of the cavity and optionally includes a Wheatstone bridge such as a quarter bridge, a half bridge, or a full bridge.

The sensing element may be secured to the internal surface of the cavity using chemical vapor deposition. Alternatively, the sensing element may be secured to the internal surface using physical vapor deposition, plasma spray, welding, brazing, or using an adhesive.

According to another embodiment, the present disclosure features a sensor for use with a hot runner system manifold. The sensor includes a plug sized and shaped to fit within a residual hole of the manifold and a substrate having a first surface adapted to be exposed to the resin in the passageway in the manifold and an internal surface that does not contact the resin. A sensing element is secured to the internal surface of the substrate. The plug may include a shank region, a flanged region, and cavity wherein the substrate is disposed proximate an internal surface of the base of the cavity. The shank region optionally includes an exterior threaded portion that is adapted to engage a corresponding threaded portion in the residual hole in the manifold. Additionally, the cavity may include an interior threaded region adapted to engage a set screw or the like that provides a more uniform contact pressure around the sealing surface of the plug. The sensing element preferably includes a Wheatstone bridge and is secured to the external surface using a method selected from the group consisting of chemical vapor deposition, physical vapor deposition, plasma spray, and an adhesive.

According to yet another embodiment, the present disclosure features a method of constructing a manifold for a hot runner system. The method includes the acts of forming a first and a second section of a passageway in a solid piece of material wherein a residual hole is created in the material during the formation of the second section. The method also includes the act of securing a sensor into the residual hole.

### BRIEF DESCRIPTION OF THE DRAWINGS

These and other features and advantages of the present disclosure will be better understood by reading the following detailed description, taken together with the drawings wherein:

FIG. 1 is cross-sectional view of one embodiment of a prior art hot runner system;

FIG. 2 is a cross-sectional view of a prior art hot runner manifold;

FIG. 3 is a close up of section III of the manifold shown in FIG. 2;

FIG. 4 is a partial cross-sectional view of one embodiment of the improved manifold and sensor according to the present disclosure;

FIG. 5 is a partial cross-sectional view of another embodiment of the improved manifold and sensor according to the present disclosure;

FIG. 6 is a cross-sectional view of one embodiment of the sensor according to the present disclosure;

FIG. 7 is a cross-sectional view of one embodiment of a prior art ejection system;

FIG. 8 is a cross-section view of one embodiment of the improved ejection system according to the present disclosure; and

FIG. 9 is a cross-section perspective view of one embodiment of the improved core and cavity plate sensors according to the present disclosure.

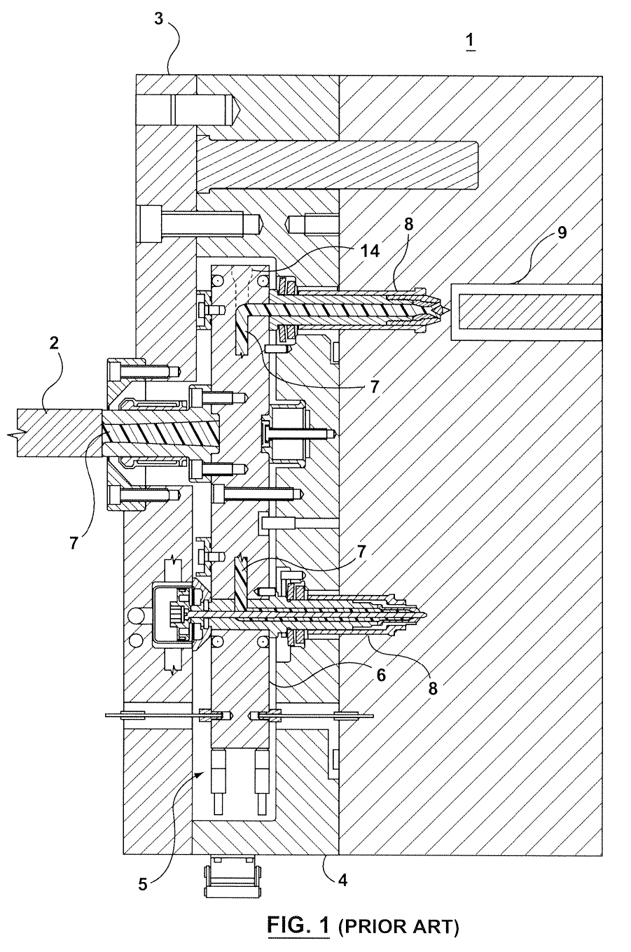

### DETAILED DESCRIPTION OF THE PREFERRED EMBODIMENTS

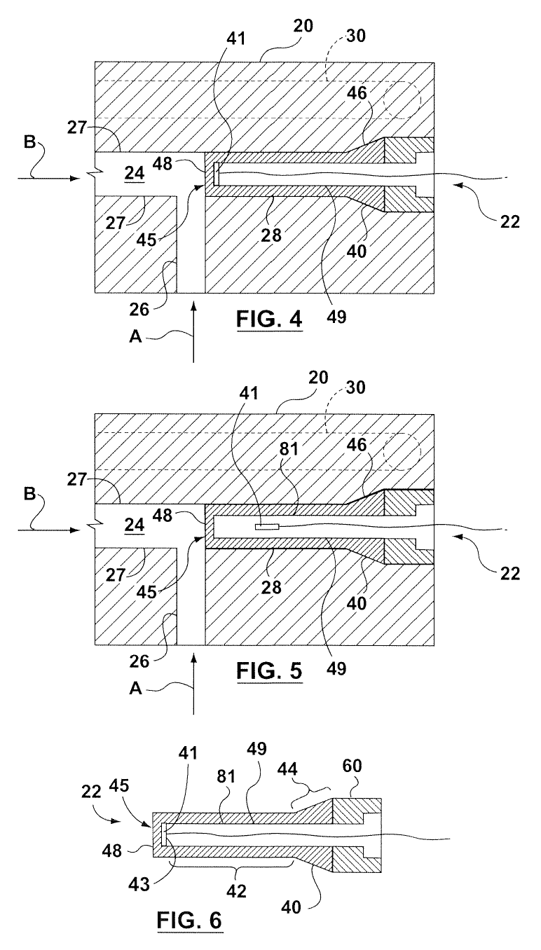

According to one embodiment, an improved manifold 20 and manifold sensor 22, FIGS. 4 and 5, may be used with a hot runner system as described above. The manifold 20 may include a passageway 24 that distributes resin to the various nozzles (not shown) which are connected to the manifold 20 and may also includes a heating device 30 (typically an electrical resistance wire or the like) in close proximity to the passageway 24. Because of the different positions of the nozzles along the manifold 20, the passageway 24 is generally not straight and typically includes segments 26, 27 at different heights, levels and/or angles. Only a small, representative portion of a typical manifold 20 and passageway 24 is shown for illustrative purposes only. Those skilled in the art will recognize that the shape, size, and configuration of the manifold 20 and the passageway 24 according to the present disclosure will depend upon the intended application.

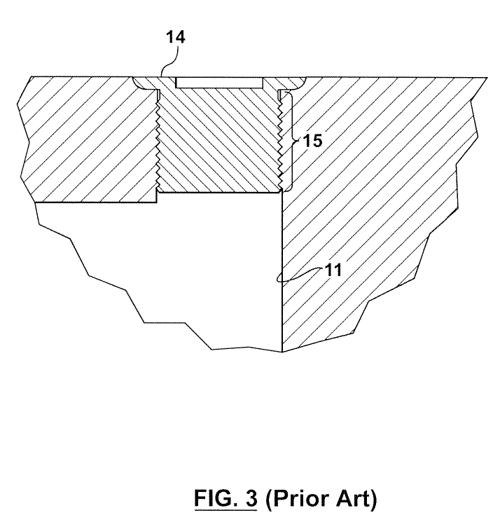

The segments 26, 27 of the passageway 24 may be formed by boring a solid block (typically steel) using a CNC machine. Because the CNC machine can only bore in a straight line, residual holes 28 are formed in the manifold 20. For illustrative purposes only, the simple passageway 24 illustrated in FIGS. 4 and 5 may be formed by first boring segment 26 in the direction of arrow A. Next, segment 27 may be formed by boring in the direction of arrow B from a different side of the manifold 20. This boring process, however, results in a residual hole 28 being created in the manifold 20. It is often necessary to seal/block-off the residual holes 28 in the passageway 24 so that the resin flows through the manifold 20 as desired. Traditionally, the residual holes 28 have been sealed using plugs 14 as shown in FIG. 3.

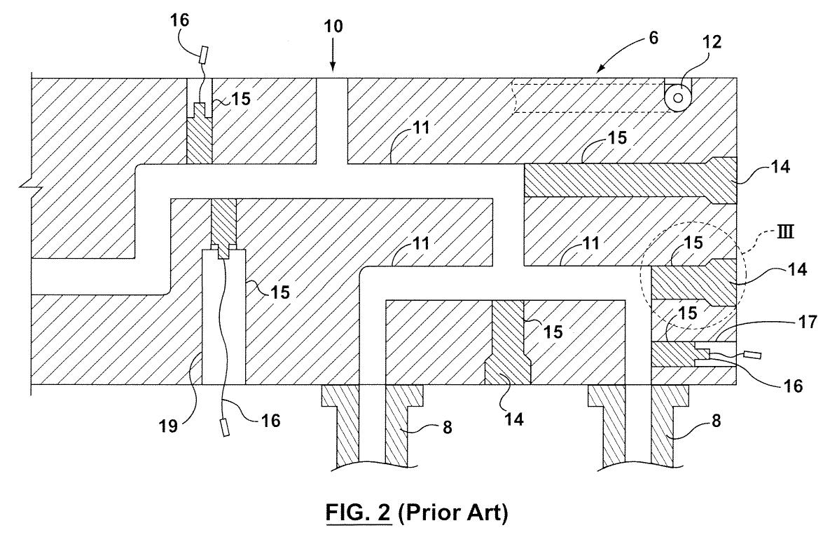

Traditionally, sensors 16, FIG. 2, are threaded into apertures 17 have been separately bored into the manifold 6 along the passageway 11. The apertures 17 must be sized and shaped to fit the sensors 16 (which are generally manufactured and sold in predefined dimensions) such that the sensors 16 contact the resin and may require boring a larger aperture 19 in order to recess the sensor 16 far enough within the manifold 6 such that the sensor 16 is in contact with the resin. Boring these apertures 17 require additional manufacturing steps and therefore add to the overall manufacturing costs and time. Additionally, boring the apertures 17 may also reduce the overall strength of the manifold 6, especially if larger apertures 19 are necessary, and may limit the placement of the sensors 16. Moreover, the seal between the apertures 17 and the sensors 16 are susceptible to resin leakage which can damage the hot runner system 1.

In contrast, one or more sensors 22, FIGS. 4 and 5, according to one embodiment of the present disclosure may be inserted in the residual holes 28 formed during the manufacturing of the passageway 24. As will be explained in greater detail hereinbelow, the sensors 22 may provide data (such as pressure and/or temperature data) that may be used by the mold processing controls (not shown) to maintain a desired temperature and/or pressure within the passageway 24 of the manifold 20 as well as the mold cavity and may also function as a traditional manifold plug. Additionally, since the sensors 22 may be disposed within the residual holes 28, it is possible to avoid having to bore additional apertures in the manifold 20. Therefore, the overall strength of the manifold 20 may be increased compared to the known manifold designs and the likelihood of damage to the hot runner system due to leakage may be reduced.

The sensor 22, FIG. 6, may include a plug 40 and a sensing element 41 disposed within a cavity 49 in the body of the plug 40. The plug 40 may be sized and shaped to seal within the residual hole 28 of the manifold 20 and may feature an elongated shank region 42. The shank 42 may include a threaded portion that threadably secures the plug 40 with the residual hole 28 or a plurality of ribs, protrusions, or the like. Alternatively, the shank 42 may be secured to the residual hole 28 using an adhesive, welding, or the like. The plug 40 may optionally include a tapered region 44 that seals against a beveled region 46 (FIGS. 4 and 5) of the residual hole 28 in the manifold 20. A bolt, a setscrew, or the like 60 may be provided within the cavity 49 to apply an axial load to the plug 40. The axial load may increase the contact pressure on the plug tapered face 44.

As discussed above, the plug 40 may feature at least one sensing element 41 secured within the internal surface 43 of the cavity 49 using any method known to those skilled in the art such as, but not limited to, chemical vapor deposition (CVD)/sputtering, physical vapor deposition (PVD), plasma spray, bonding with adhesives, welded (for example metal backing on sensor), and ink jet printing. As used herein, the internal surface 43 of the cavity 49 is intended to denote a surface of the plug 40 that does not come into direct contact with the resin when the plug 40 is inserted within the residual hole 28 of the manifold 20.

According to one embodiment, the sensing element 41, FIG. 4, may be secured to the base 48 of the cavity 49. The base 48 of the cavity 49 may form a flexible substrate having an external surface 45 that is substantially directly exposed to the resin within the passageway 24 when the plug 40 is disposed within the manifold 20. As will be discussed in greater detail hereinbelow, the sensing element 41 disposed on the internal surface 43 of the cavity 49 can be used to calculate pressure by measuring the bending or strain of the flexible substrate.

Alternatively (or in addition), a sensing element 41 may be secured to the sidewall 81, FIG. 5, of the cavity 49. In this case, the sensing element 41 may calculate pressure by measuring the axial compression of the sidewall 81 as will be discussed in further detail hereinbelow. The sensor 22 shown in FIG. 4 may generally provide a more accurate pressure measurement compared to the sensor 22 shown in FIG. 5, however, the sensor 22, FIG. 4, may be difficult to install in deep holes 28. As a result, the sensor 22, FIG. 4, is generally preferable for short plugs 40 whereas the sensor 22, FIG. 5, is generally preferable for longer plugs 40. However, this is not a limitation of the present disclosure unless specifically claimed as such.

While the sensing element 41 may include any sensing element known to those skilled in the art, the sensing element 41 may include a Wheatstone bridge configuration such as a quarter bridge (one active sensor and three passive sensors), a half bridge (two active sensors and two passive sensors), or a full bridge (four active sensors). The passive sensors may be either included on the sensing plug or contained within a separate data acquisition system. The Wheatstone bridge may be used to measure the change in strain on the internal surface 43 of the cavity 49 as resin pressure is applied to the external surface 45 of the plug 40. The strain measurement on the internal surface 43 of the cavity is generally directly related to the resin pressure on the external surface 45 so that the cavity 49 can be, but is not limited to, a measurement of the resin pressure. The sensors in the Wheatstone bridge may also be used to monitor temperature.

Whereas the traditional manifold sensors have limited placement on the manifold due to the limited number of available sizes/shapes and often require boring larger holes to recess the sensor, the sensors 22 according to the present disclosure may be placed virtually anywhere on the manifold 20 and may be easily and inexpensively customized because the plugs 40 may be manufactured separately from the sensing elements 41. The increased flexibility in locating the sensors 22 within the manifold 20 allows sensors 22 to be placed at different locations along the passageway 24 at equal melt flow distances from the injection machine. Moreover, since the sensing elements 41 described above do not need to be in direct contact with the resin in the manifold 20, the residual holes 28 do not need to be enlarged in order to recess the sensor 22. As a result, the overall strength of the manifold 20 may be increased thereby allowing the sensors 22 to be placed in more locations.

Additionally, the manifold 20 according to one embodiment of the present disclosure may feature a larger number of sensors 22 compared to the known designs without adding complexity/cost to the manufacturing process. The additional number of sensors 22 of this embodiment allows the hot runner control system to monitor and compare temperature and/or pressure readings within multiple locations within the manifold 20 and to use the feedback from all the sensors 22 to raise/lower temperature/pressure of the resin in the various flow locations of the passageway 24 of the manifold 20, thereby increasing the overall control of the hot runner system. Using a large number of the prior art sensors 16 is generally not practical, however, because each sensor 16 requires boring an additional hole 17 in the manifold 6 as discussed above.

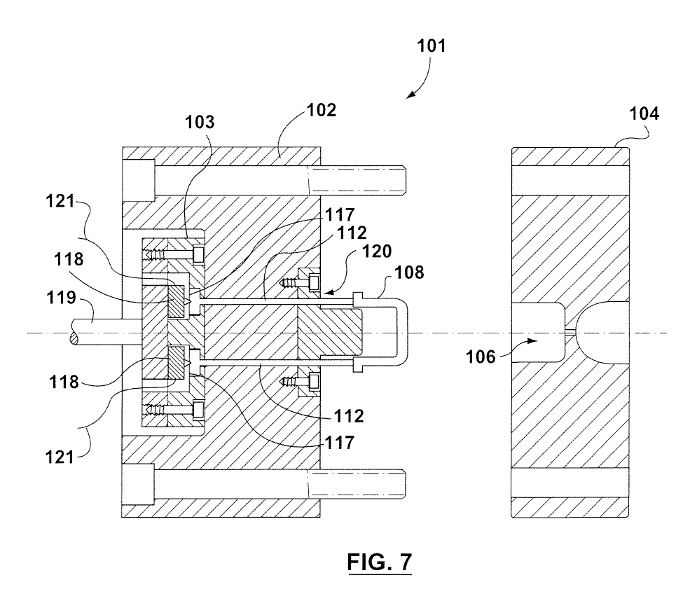

One embodiment of typical mold stack 101 for producing part 108 out of resin is shown in FIG. 7. A mold stack 101 may generally feature two mold plates, namely, a core plate 102 and a cavity plate 104. Resin may be introduced into the cavity 106 formed by the plates 102, 104 to form the part 108 being manufactured. Once the part 108 has sufficiently solidified, the core plate 102 moves in the direction of arrows 110 relative to the cavity plate 104 (which is usually stationary) to allow the part 108 to be removed from the plates 102, 104. However, the part 108 may remain attached to the core plate 102 and one or more ejector pins 112 are used to separate the part 108 from the core plate 102. The ejector pins 112 may extend outwardly from the core plate 102 and push against the part 108, thereby separating the part 108 from the core plate 102.

The force exerted by the ejector pins 112 against the part 108 must be sufficiently large to overcome the forces holding the part 108 to the core plate 102. However, if the force exerted by the ejector pin 112 is too large, the ejector pins 112 can damage the part 108. While it is known to place a pressure sensor 118 between the end 117 of the ejector pin 112 and the ejector bolt 119 to monitor the pressure exerted by the ejector pin 112, this arrangement suffers from several limitations.

For example, adding a pressure sensor 118 between the bolt 119 and ends 117 of the ejector pins 112 of an existing mold stack 101 may move the ejector pin 112 outwards beyond the surface 120 of the core plate 102. Moreover, the addition of the pressure sensor 118 adds an additional component (with its own production tolerances) and therefore adds to the stacking tolerances which must be factored into the design of the ejector pin 112. In an existing mold stack 101, the ejector pin 112 must be modified to prevent the distal end of the ejector pin 112 from extending into the cavity 106 during the molding of the part 108.

Another limitation of this arrangement is that the pressure sensor 118 may be difficult to fit between the bolt 119 and the ejector pin 112. For example, there may be very little space to route the wires 121 connecting the sensor 118 to a processor (not shown) and it may be necessary to route the wires 121 close to moving parts (e.g., the bolt 119) which can damage the wires 121 if they come into contact with a moving part.

Yet a further limitation of this arrangement is that the pressure sensor 118 may wear out quickly. The pressure sensor 118 substantially directly contacts the ejector bolt 119 and the ejector pin 112. Because the bolt 119 and the ejector pin 112 may move slightly relative to each other, the pressure sensor 118 is subjected to constant friction that may damage the pressure sensor 118.

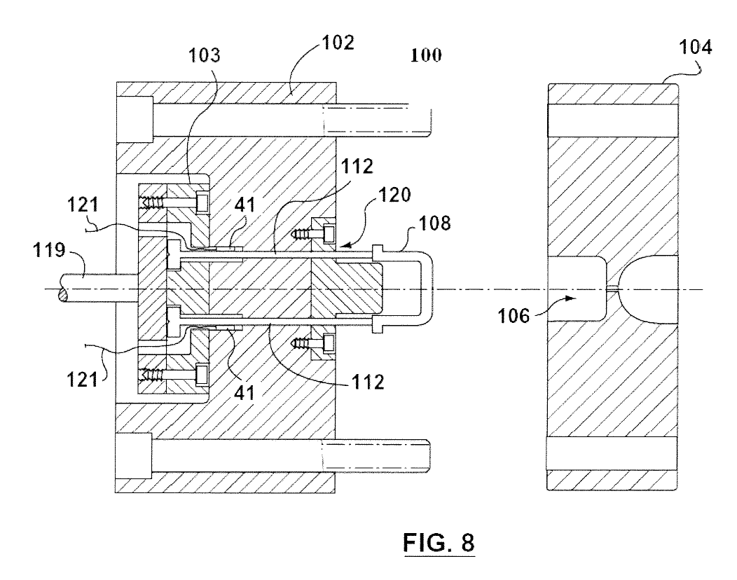

According to one embodiment, the present disclosure may include an improved ejection system 100, FIG. 8. The improved ejection system 100 may include one or more sensing elements 41 secured to the outer or exterior sidewall 115 of at least one ejector pin 112 rather then the ends 117 of the ejector pin 112. The sensing element 41 may be used to monitor the forces exerted by the ejector pins 112 during part ejection. Additionally, the sensing element 41 may also be used to monitor cavity pressure and/or temperature while the cavity 106 is being filled with resin. Monitoring the cavity pressure and/or temperature is particularly useful for purposes of molding process control.

The sensing element 41 may include any sensing element known to those skilled in the art (such as, but no limited to, a Wheatstone bridge configuration as discussed above) and may be secured to the ejector pin 112 using any method known to those skilled in the art. For example, the sensing element 41 may be secured to the ejector pin 112 using chemical vapor deposition (CVD)/sputtering, physical vapor deposition (PVD), plasma spray, bonding with adhesives, welded (for example metal backing on sensor), and ink jet printing.

Since the sensing element 41 may be secured to the outer sidewall 115 rather than the end 117 of the ejector pin 112, the sensing element 41 according to one embodiment of the present disclosure may be easily retrofitted to existing mold stacks 101 without having to modify the ejector pin 112. Furthermore, since the sensing element 41 may be placed on the sidewall 115 of the ejector pin 112, the sensing element 41 does not add to stacking tolerance of ejection system 100. The sensing element 41 also is not subjected to the contact forces experienced by the known ejector pin pressure sensor arrangement and therefore will have a much longer lifespan. Additionally, the sensing element 41 may be placed virtually anywhere along the ejector pin 112 thereby facilitating the routing of the sensing element 41 wires 121.

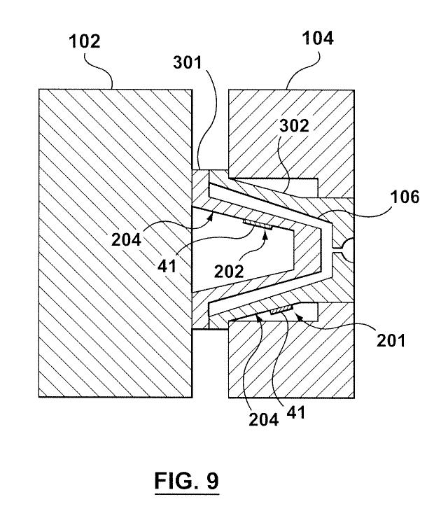

Traditionally, in order to directly monitor the temperature and/or pressure of the cavity 106, FIG. 9, it was generally necessary to drill an aperture (not shown) into the core insert 301 and/or the cavity insert 302 and insert a traditional sensor (not shown) into the cavity 106 such that the sensor contacts the resin in the cavity 106. Unfortunately, this arrangement suffers from several limitations and may not be practical in some circumstances. For example, the parts 108 being manufactured (and consequently the cavity 106) are may be extremely small. In some applications, the existing sensors may simply be too large to integrate into the core and/or cavity inserts 301, 302. Another limitation with the known arrangement is that the sensors directly contact the resin in the mold 106. As a result, the sensors may create aesthetic imperfections in the molded part 108 which may not be acceptable to the end user. Moreover, the creation of the apertures in the core and/or cavity inserts 301, 302 may weaken the overall strength of the core and/or cavity inserts 301, 302. As a result, the core and/or cavity inserts 301, 302 may not be sufficiently strong enough to withstand the forces experienced during use and may substantially shorten the lifespan of the core and/or cavity inserts 301, 302.

According to one embodiment, the present disclosure may include a cavity sensor 201, FIG. 9, and core sensor 202 for monitoring the pressure and/or temperature of the cavity 106. The cavity sensor 201 and core sensor 202 may each feature at least one sensing element 41 as described above that may be secured to an exterior surface 204 of the core insert 301 and/or cavity insert 302. As used herein, the exterior surface 204 of the core insert 301 and cavity insert 302 is intended to denote surfaces of the core and cavity inserts 301, 302 that do not come into contact with the resin when the mold 106 is being filled.

Since the cavity sensor 201 and core sensor 202 do not contact the resin, the cavity sensor 201 and core sensor 202 do not generate imperfections in the molded part 108. Additionally, the cavity sensor 201 and core sensor 202 do not require apertures to be drilled into the core and/or cavity inserts 301, 302 and therefore do not weaken the strength of the core and/or cavity inserts 301, 302 and may be more easily integrated onto the core and/or cavity inserts 301, 302.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A hot runner manifold system comprising:
a manifold having at least one passageway for transmitting a resin between at least one inlet and outlet, said passageway further including at least one residual hole; and
a plug including:
an external surface sized and shaped to seal with said residual hole, wherein at least a portion of said external surface is in direct contact with said resin in said passageway when said plug is disposed within said residual hole;
a cavity having an internal surface that does not contact said resin when said plug is disposed within said residual hole; and
a sensor secured to said internal surface of said cavity.

2. The hot runner manifold system as claimed in claim 1 wherein said sensor is secured to said internal surface of a sidewall of said cavity.

3. The hot runner manifold system as claimed in claim 1 wherein said sensor is secured to said internal surface of a base of said cavity.

4. The hot runner manifold system as claimed in claim 3 wherein an external surface of said base of said cavity is in direct contact with said resin in said passageway when said plug is disposed within said residual hole.

5. The hot runner manifold system as claimed in claim 1 wherein said sensing element includes a Wheatstone bridge.

6. The hot runner manifold system as claimed in claim 5 wherein said Wheatstone bridge includes a quarter bridge.

7. The hot runner manifold system as claimed in claim 5 wherein said Wheatstone bridge includes a half bridge.

8. The hot runner manifold system as claimed in claim 5 wherein said Wheatstone bridge includes a full bridge.

9. The hot runner manifold system as claimed in claim 1 wherein said sensing element is secured to said internal surface using chemical vapor deposition.

10. The hot runner manifold system as claimed in claim 1 wherein said sensing element is secured to said internal surface using physical vapor deposition.

11. The hot runner manifold system as claimed in claim 1 wherein said sensing element is secured to said internal surface using plasma spray.

12. The hot runner manifold system as claimed in claim 1 wherein said sensing element is secured to said internal surface using an adhesive.

13. The hot runner manifold system as claimed in claim 1 wherein said plug includes a shank region and a flanged region adapted to seal with said residual hole.

14. The hot runner manifold system as claimed in claim 13 wherein said shank includes an externally threaded region adapted to engage a threaded region of said residual hole.

15. A sensor for use with a hot runner system manifold having at least one passageway for the distribution of resin and at least one residual hole, said sensor comprising:
a body portion having an external surface sized and shaped to seal with said residual hole and a first and a second end portion, wherein at least a portion of said external surface of said first end portion is adapted to be in direct contact with said resin in said passageway when said plug is disposed within said residual hole;
a cavity disposed within said body portion, said cavity having an internal surface that does not contact said resin when said plug is disposed within said residual hole; and
a sensing element secured to said internal surface of said cavity.

16. The sensor as claimed in claim 15 wherein said body portion further includes a shank region, and a flanged region.

17. The sensor as claimed in claim 16 wherein said sensing element is secured to said internal surface of a base region of said cavity said shank region includes a threaded portion, wherein said threaded portion is adapted to engage a corresponding threaded portion in said residual hole in said manifold.

18. The sensor as claimed in claim 16 wherein said sensing element is secured to said internal surface of a sidewall of said cavity said sensing element includes a Wheatstone bridge.

19. The sensor as claimed in claim 16 wherein said sensing element includes a Wheatstone bridge secured to said internal surface of said cavity using a method selected from the group consisting of chemical vapor deposition, physical vapor deposition, plasma spray, and an adhesive.

20. A method of constructing a manifold for a hot runner system, said method comprising the acts of:
forming a first section of a passageway in a solid piece of material;
forming a second section of said passageway in said material, said act of forming said second section including forming a residual hole in said material; and
securing a sensor into said residual hole.

21. The method as claimed in claim 20 wherein said act of securing said sensor into said residual hole further includes the act of sealing a plug into said residual hole and securing a sensing element to an internal surface of a cavity disposed in said plug.

22. The method as claimed in claim 21 wherein said act of securing said sensing element further includes securing said sensing element using a method selected from the group consisting of chemical vapor deposition, physical vapor deposition, plasma spray, and an adhesive.

23. An ejector system comprising:
a first and a second mold plate defining a mold cavity for forming a molded part;
means for moving said at least one of said mold plates with respect to the other mold plate;
at least one ejector pin having a first and a second end disposed generally opposite from each other and a sidewall;
means contacting said first end of said at least one ejector pin for moving said at least one ejector pin from a retracted position to and extended position wherein said second end of said at least one ejector pin contacts said at least a portion of said molded part; and
at least one sensing element secured to said sidewall of said at least one ejector pin.

24. A mold comprising:
a first and a second mold insert each comprising an external surface and an internal surface, said internal surfaces defining a mold cavity configured to accept resin; and
at least one sensing element secured to said external surface of at least one of said first and said second mold inserts wherein said at least one sensing element does not contact said internal surface of said mold cavity.

25. The mold as claimed in claim 24 wherein said at least one sensing element is secured to said external surface of said at least one of said first and said second mold inserts using chemical vapor deposition, physical vapor deposition, plasma spray, or an adhesive.
